(19) United States
(12) Patent Application Publication
(10) Pub. No.: US 2019/0005432 A1
(43) Pub. Date: Jan. 3, 2019

(54) EVALUATION APPARATUS AND EVALUATION METHOD

(71) Applicant: FUJITSU LIMITED, Kawasaki-shi (JP)

(72) Inventors: Shunichi Obinata, Kawasaki (JP); Katsuaki Kawaguchi, Toyoake (JP)

(73) Assignee: FUJITSU LIMITED, Kawasaki-shi (JP)

(21) Appl. No.: 16/000,591

(22) Filed: Jun. 5, 2018

(30) Foreign Application Priority Data
Jun. 29, 2017 (JP) 2017-127763

(51) Int. Cl. G06Q 10/06; G06Q 30/00; G06F 17/30

(52) U.S. Cl. CPC G06Q 10/06395; G06F 17/30946; G06Q 30/016

(57) ABSTRACT

An evaluation apparatus includes a memory and a processor configured to specify, in response to receiving an answer regarding a first incident, a first incident category related to the first incident in accordance with management information of a plurality of incidents, select a first criterion related to the specified first incident category from criterions regarding evaluation for each incident category, perform evaluation of the answer in accordance with the selected first criterion, and perform outputting a result of the evaluation of the answer.

### CROSS-REFERENCE TO RELATED APPLICATION

This application is based upon and claims the benefit of priority of the prior Japanese Patent Application No. 2017-127763, filed on Jun. 29, 2017, the entire contents of which are incorporated herein by reference.

### FIELD

The embodiments discussed herein are related to evaluation techniques and proofreading techniques.

### BACKGROUND

In information services, incident management is carried out. The term incident as used herein refers to a trouble or an inquiry about security or the like, for example, of a computer or a network. In the incident management, an incident and an answer statement for the incident are managed in combination.

In cases where an answer statement for an incident is proofread, the proofreading definition is to be changed for each user who has issued the incident or for each business process or use case. The proofreading definition is manually changed for each user, business process, or use case. For example, the administrator of an incident specifies an answer file and a proofreading definition file for the incident as parameters for a proofreading command on a computer. In such a case, a technique is known in which the computer uses the proofreading definition file to collectively modify the inside of the answer file for the incident.

Related techniques are disclosed, for example, in Japanese Laid-open Patent Publication No. 2013-41384 and Japanese Laid-open Patent Publication No. 2008-145769.

### SUMMARY

According to an aspect of the invention, an evaluation apparatus includes a memory and a processor configured to specify, in response to receiving an answer regarding a first incident, a first incident category related to the first incident in accordance with management information of a plurality of incidents, select a first criterion related to the specified first incident category from criterions regarding evaluation for each incident category, perform evaluation of the answer in accordance with the selected first criterion, and perform outputting a result of the evaluation of the answer.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a functional block diagram illustrating a configuration of an evaluation apparatus according to an embodiment;

FIG. 2 is a diagram illustrating an example of a data structure of an incident management table;

FIG. 3 is a diagram illustrating an example of a data structure of a definition file management table;

FIG. 4 is a diagram illustrating an example of a data structure of a determination function management table;

FIG. 5 is a diagram illustrating an example of a data structure of a sample definition file;

FIG. 6 is a diagram illustrating an example of summing processing according to an embodiment;

FIG. 7 is a diagram illustrating an example of determination processing according to an embodiment;

FIG. 8 is a diagram illustrating an example of a definition file for business process A;

FIG. 9A is a diagram (1) illustrating an example of a screen image of an evaluation process according to an embodiment;

FIG. 9B is a diagram (2) illustrating an example of a screen image of the evaluation process according to the embodiment;

FIG. 9C is a diagram (3) illustrating an example of a screen image of the evaluation process according to the embodiment;

FIG. 10 is a diagram illustrating an example of a flowchart of an evaluation process according to an embodiment;

FIG. 11 is a diagram illustrating an example of a flowchart of a definition file generation process according to an embodiment; and

FIG. 12 is a diagram illustrating an example of a computer that executes an evaluation program.

### DESCRIPTION OF EMBODIMENTS

Conventional techniques have a problem in that when an answer statement for an incident is proofread, a computer is unable to automatically change a proofreading definition in accordance with the user who has issued the incident, or in accordance with a business process or a use case. Accordingly, in some cases, the computer executes a proofreading process based on a proofreading definition that is not suitable for circumstances for performing proofreading.

Hereinafter, embodiments of an evaluation program, an evaluation apparatus, and an evaluation method disclosed herein will be described in detail with reference to the accompanying drawings. Note that the present disclosure is not limited to the embodiments.

### EMBODIMENTS

Configuration of Evaluation Apparatus

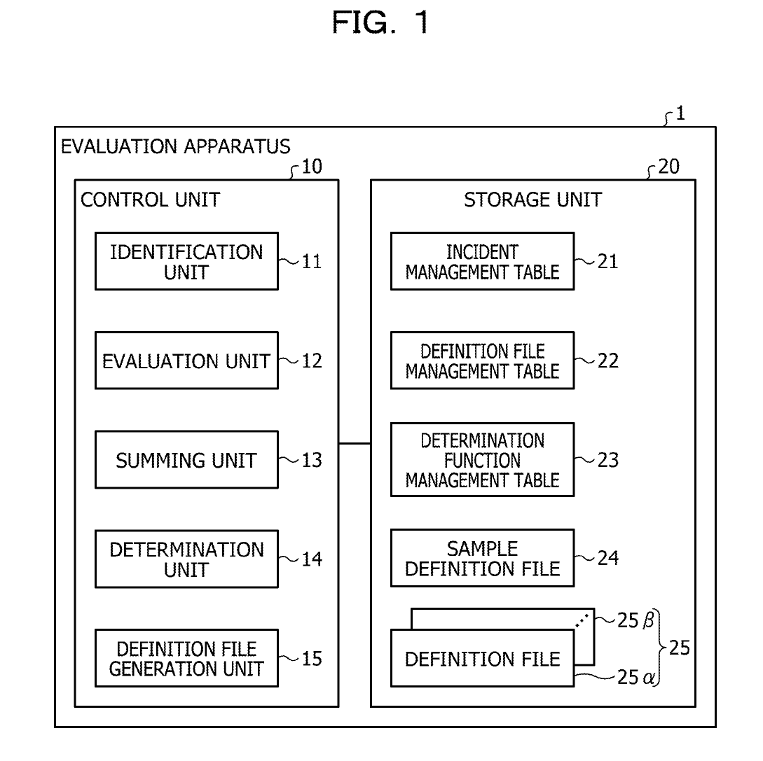

FIG. 1 is a functional block diagram illustrating a configuration of an evaluation apparatus according to an embodiment. Upon accepting specification of an incident, an evaluation apparatus 1 identifies a category (for example, a business process) corresponding to the specified incident and identifies a definition file corresponding to the identified category. Then, based on the identified definition file, the evaluation apparatus 1 performs an evaluation (proofreading) of an answer statement for the incident corresponding to the identified category. The term incident as used herein refers to a trouble or an inquiry about security and the like of a computer or a network. In embodiments, the incident, for example, may be an inquiry about a trouble for a business process, may be an inquiry about a trouble from the user, or may be an inquiry in various use cases.

As illustrated in FIG. 1, the evaluation apparatus 1 includes a control unit 10 and a storage unit 20.

The control unit 10 corresponds to an electronic circuit such as a central processing unit (CPU). The control unit 10 includes an internal memory for storing programs that define various processing procedures and for storing control data, and performs various types of processing by using these programs and data. The control unit 10 includes an identification unit 11, an evaluation unit 12, a summing unit 13, a determination unit 14, and a definition file generation unit 15.

The storage unit 20 is, for example, a semiconductor memory device such as random access memory (RAM) or flash memory, or a storage device such as a hard disk or an optical disk. The storage unit 20 includes an incident management table 21, a definition file management table 22, a determination function management table 23, a sample definition file 24, and definition files 25.

The sample definition file 24 is a definition file used in evaluating an answer statement for an incident and is a definition file of samples. In the sample definition file 24, items that are indicated in evaluation are set. Note that the sample definition file 24 is created in advance by the administrator.

The definition file 25 is a definition file used in evaluating an answer statement for an incident and is a definition file for each of attribute categories of business processes, users, various use cases, and the like. The term attribute category as used herein refers to, by way of example, an individual business process name in the case where the attribute is a business process. By way of another example, in the case where the attribute is the user, the term attribute category refers to an individual user name. By way of another example, in the case where the attribute is a product (component), the term attribute category refers to an individual product (component) name. Hereinafter, in order to discriminate a plurality of definition files 25 by attribute category, the definition files will be referred to as “definition file 25α”, “definition file 25β”, and so on. Each of the definition files will be referred to as a “definition file 25” if described without discrimination from each other. Note that the definition file 25 is generated by attribute category by the definition file generation unit 15.

The incident management table 21 manages incidents. For example, the incident management unit 21 manages, for an incident, an inquiry statement and an answer statement that has been evaluated and modified, and also manages a contact person and reviewers involved in the evaluation of the answer statement. Note that each incident is added to the incident management table 21 at a timing at which the incident is received, and the incident management table 21 is updated by the evaluation unit 12.

The definition file management table 22 manages definition files for each attribute category. Note that the definition file management table 22 is created in advance by the administrator.

The determination factor management table 23 manages determination factors used in generating definition files for each attribute category of an incident. Note that the determination factor management table 23 is created in advance by the administrator.

Upon accepting specification of an incident, the identification unit 11 identifies an attribute category corresponding to the specified incident by referencing the incident management table 21. For example, by referencing the incident management table 21, the identification unit 11 extracts a record corresponding to the specified incident and identifies the attribute category of the extracted record. Note that the identification unit 11 may identify the attribute category by lexical analysis of the content of the inquiry in a record corresponding to the specified incident.

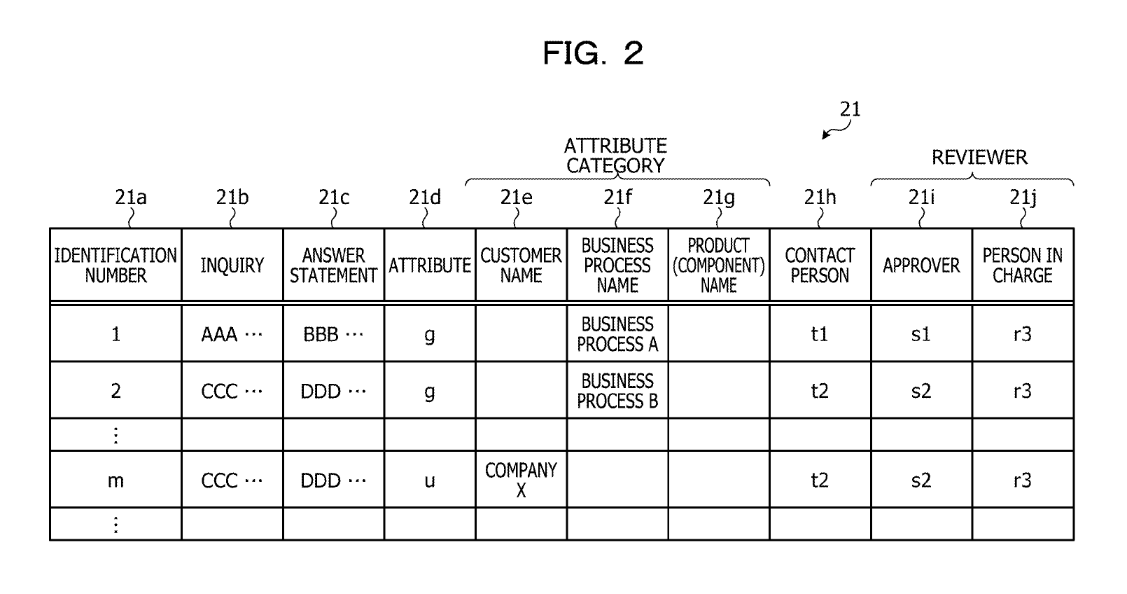

Here, an example of the data structure of the incident management table 21 will be described with reference to FIG. 2. FIG. 2 is a diagram illustrating an example of a data structure of an incident management table. As illustrated in FIG. 2, the incident management table 21 stores an identification number 21a, an inquiry 21b, an answer statement 21c, an attribute 21d, a customer name 21e, a business process name 21f, a product (component) name 21g, a contact person 21h, an approver 21i, and a person in charge 21j in association with each other. The customer name 21e, the business process name 21f, and the product name 21g correspond to attribute categories. The approver 21i and the person in charge 21j correspond to reviewers.

The identification number 21a is a number that identifies one incident.

The inquiry 21b represents inquiry content of an incident. The answer statement 21c represents an answer statement for an incident. The answer statement 21c is a statement proofread by using the sample definition file 24.

The attribute 21d represents the attribute of an incident. For example, in the case of an incident regarding a business process, an attribute “g” corresponding to a business process is set. In the case of an incident regarding a customer, an attribute “u” corresponding to a customer is set. In the case of an incident regarding a product or a component, an attribute “p” corresponding to a product or a component is set. Note that the attribute 21d is not limited to the attributes corresponding to a business process, a customer, and a product (component).

The customer name 21e is an attribute category used when the attribute of an incident corresponds to a customer. The business process name 21f is an attribute category used when the attribute of an incident corresponds to a business process. The product (component) name 21g is an attribute category used when the attribute of an incident corresponds to a product (component).

The contact person 21h is a contact person for an incident who has charge of preparing an answer statement for the incident. The approver 21i is a person who approves an answer statement for an incident. The person in charge 21j is a person who is in charge of an incident and who approves an answer statement for the incident.

By way of example, in the case where the identification number 21a is “1”, “AAA . . . ” as the inquiry 21b and “BBB . . . ” as the answer statement 21c are stored. In addition, “g” as the attribute 21d and “business process A” as the business process name 21f are stored. In addition, “t1” as the contact person 21h, “s1” as the approver 21i, and “r3” as the person in charge 21j are stored. For example, by referencing the incident management table 21, the identification unit 11 may extract a record corresponding to the inquiry 21b that matches the specified incident, and may identify the attribute categories 21e to 21g corresponding to the attribute 21d of the extracted record.

With reference now to FIG. 1, the identification unit 11 identifies a definition file corresponding to the identified attribute category by referencing the definition file management table 22.

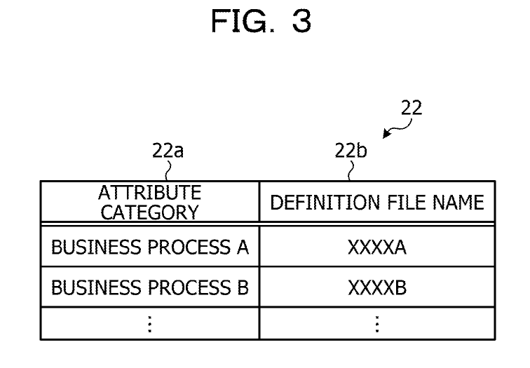

Here, an example of the data structure of the definition file management table 22 will be described with reference to FIG. 3. FIG. 3 is a diagram illustrating an example of a data structure of a definition file management table. As illustrated in FIG. 3, the definition file management table 22 stores an attribute category 22a and a definition file name 22b in association with each other.

The attribute category 22a is a specific classification in each attribute. In the attribute category 22a, for the cases where the attribute is a business process, attributes are classified according to the business process name. For the cases where the attribute is a customer, attributes are classified according to the customer name. For the cases where the attribute is a product (component), attributes are classified according to the product name or the component name. Note that the attribute category 22a corresponds to the customer name 21e, the business process name 21f, and the product (component) name 21g in the incident management table 21.

The definition file name 22b is the name of a definition file. The name of the sample definition file 24 is set by default for the definition file name 22b. When a definition file is generated by the definition file generation unit 15, the definition file name 22b is updated with the name of the generated definition file.

By way of example, in the case of the attribute category 22a of “business process A”, “xxxxA” is stored as the definition file name 22b. In the case of the attribute category 22a of “business process B”, “xxxxB” is stored as the definition file name 22b.

With reference now to FIG. 1, upon accepting input of an answer statement regarding an incident, the evaluation unit 12 evaluates (proofreads) an answer statement the input of which has been accepted, based on a definition file identified by the identification unit 11.

For example, the evaluation unit 12 determines whether an indicated item defined in the identified definition file is present in the answer statement the input of which has been accepted. The evaluation unit 12 displays the indicated item present in the answer statement as an indication result. Then, when an indication to be used is selected by a contact person, the evaluation unit 12 reflects the selected indication in the answer statement. That is, if the identified definition file is the sample definition file 24, the evaluation unit 12 modifies the answer statement such that an error 24b of an indication number 24a of the selected indication is replaced with a correction 24c. If the identified definition file is the definition file 25, the evaluation unit 12 modifies the answer statement such that an error 25b of an indication number 25a of the selected indication is replaced with a correction 25c.

By referencing the incident management table 21, the evaluation unit 12 also extracts a record corresponding to the inquiry 21b that matches the incident. Then, the evaluation unit 12 sets a modified answer statement for the answer statement 21c of the extracted record and sets the name of a contact person for the contact person 21h of the extracted record. In addition, upon approval of the answer statement 21c for the incident by a reviewer, if the reviewer is an approver, the evaluation unit 12 sets the name of the approver for the approver 21i of the extracted record. If the reviewer is a person in charge, the evaluation unit 12 also sets the name of the person in charge for the person in charge 21j of the extracted record.

The summing unit 13 references the incident management table 21 to obtain the summed number of contact persons and of reviewers involved in indication for each indicated item for a given attribute category. For example, upon accepting specification of an attribute category for which a definition file is desired to be generated, the summing unit 13 references the incident management table 21 to search for answer statements corresponding to the attribute category the specification of which has been accepted. The summing unit 13 identifies a definition file corresponding to the attribute category by referencing the definition file management table 22. The summing unit 13 selects the answer statements searched for, one by one, and, upon accepting input of the selected answer statement, reevaluates the answer statement by using the identified definition file. For the indication number of an item indicated as a result of reevaluation, the summing unit 13 counts the number of contact persons and reviewers involved in this indication on the original evaluation occasion. That is, the summing unit 13 reevaluates the answer statement after already being modified, and obtains the summed number of contact persons and reviewers involved in indication for each indicated item that has been indicated but determined not to be used on the original evaluation occasion. The reason why the indicated items that have been determined not to be used on the original evaluation occasion are subjected to summing is that an indicated item that has been determined to be used, on the original evaluation occasion, is already corrected, resulting in not being indicated on the reevaluation occasion, and only an indicated item that has been determined not to be used, on the original evaluation occasion, is indicated. Obtaining the summed number of contact persons and reviewers involved in indication enables the summing unit 13 to detect that it is valid that this indication has not been used. Note that including the same person more than once in the number of contact persons and reviewers involved in the indication is to be avoided. In addition, the summed number of contact persons and reviewers involved in indication for an indicated item is an example of the selection status of the indicated item.

The determination unit 14 evaluates, for each indicated item, whether it is valid that the indicated item has not been used. For example, the determination unit 14 identifies, for each indication number, the summed number of contact persons and reviewers involved in the indication, which has been obtained by the summing unit 13. The determination unit 14 references the determination function management table 23 and acquires a determination function corresponding to the specified attribute category. Then, by using the acquired determination function, the determination unit 14 calculates, for each indication number, a determination value corresponding to the summed number of contact persons and reviewers involved in the indication. Then, if the calculated determination value is greater than or equal to a threshold, the determination unit 14 adds the indication number for the indicated item to a white list. The term white list as used herein refers to a list of indicated items for which the determination is that it is valid that these indicated items have not been used. Note that the threshold, which is, for example, 80%, is examined in advance by an experiment or the like and the information is stored in the storage unit 20.

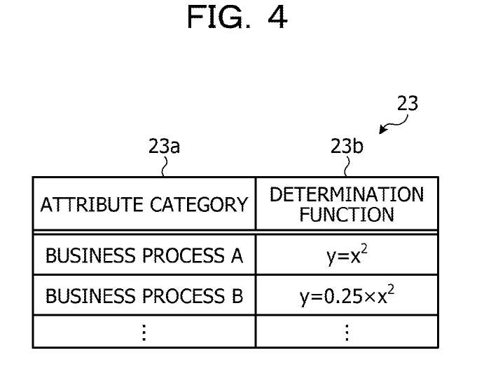

Here, an example of the data structure of the determination function management table 23 will be described with reference to FIG. 4. FIG. 4 is a diagram illustrating an example of a data structure of a determination function management table. As illustrated in FIG. 4, the determination function management table 23 stores an attribute category 23a and a determination function 23b in association with each other.

The attribute category 23a is a specific classification in each attribute. In the attribute category 23a, for the cases where the attribute is a business process, attributes are classified according to the business process name. For the cases where the attribute is a customer, attributes are classified according to the customer name. For the cases where the attribute is a product (component), attributes are classified according to the product name or the component name. Note that the attribute category 23a corresponds to the customer name 21e, the business process name 21f, and the product (component) name 21g of the incident management table 21.

The determination function 23b is a function used in generating a definition file for each attribute category of an incident. The determination function 23b is, for example, a function assuming that, for an indicated item defined in the sample definition file 24, the summed number of contact persons and reviewers who have not used this indicated item on the occasion of evaluation is the X-coordinate and the determination value is the Y-coordinate. The term determination value as used herein refers to the level for determining whether it is valid that this indication has not been used. That is, the determination function 23b represents a function with which the larger the summed number of contact persons and reviewers who have not used the indication, the higher the determination value.

By way of example, in the case of the attribute category 23a of “business process A”, “y=x²” is stored as the determination function 23b. In the case of the attribute category 23a of “business process B”, “y=0.25×x²” is stored as the determination function 23b.

With reference now to FIG. 1, the definition file generation unit 15 generates the definition file 25 corresponding to an attribute category. For example, the definition file generation unit 15 references the definition file management table 22 to identify a definition file corresponding to an attribute category. The definition file generation unit 15 reads the identified definition file and removes the indicated items with indication numbers set in the white list among indication numbers defined in the read definition file. Then, assuming the indicated items with a plurality of indication numbers remaining after this removal, as indicated items corresponding to the specified attribute category, the definition file generation unit 15 generates the definition file 25 corresponding to this attribute category. Then, the definition file generation unit 15 updates the definition file name corresponding to the specified attribute category in the definition file management table 22 to the name of the generated definition file 25.

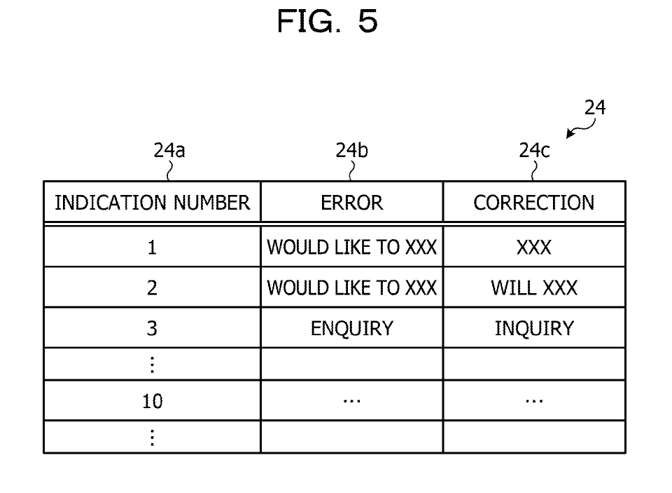

Here, an example of the data structure of the sample definition file 24 will be described with reference to FIG. 5. FIG. 5 is a diagram illustrating an example of a data structure of a sample definition file. As illustrated in FIG. 5, the sample definition file 24 stores the indication number 24a, the error 24b, and the correction 24c in association with each other. The indication number 24a represents the number of identifying an indication. The error 24b represents the content of an item indicated as an error. The correction 24c represents the content of an item indicated as a correction. That is, with the error 24b and the correction 24c, what is to be modified and in what manner the modification is to be made is indicated. Note that the sample definition file 24 may be provided for each attribute. That is, the sample definition file 24 for business processes, the sample definition file 24 for customers, and the sample definition file 24 for products (components) may be provided. In addition, a single sample definition file 24 may be provided for all the attributes.

By way of example, for the indication number 24a of “1”, “would like to xxx” is stored as the error 24b, and “xxx” is stored as the correction 24c. For the indication number 24a of “2”, “would like to xxx” is stored as the error 24b, and “will xxx” is stored as the correction 24c. For the indication number 24a of “3”, “enquiry” is stored as the error 24b, and “inquiry” is stored as the correction 24c.

### Example of Summing Processing

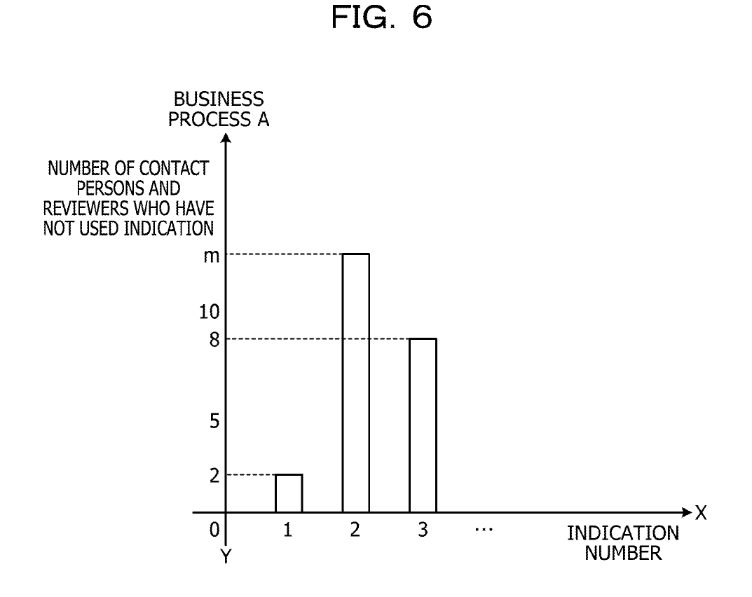

FIG. 6 is a diagram illustrating an example of summing processing according to an embodiment. Note that, with reference to FIG. 6, summing processing for the attribute category of business process A will be described.

As illustrated in FIG. 6, the X-coordinate represents the indication number and the Y-coordinate represents the summed number of contact persons and reviewers who have not used the indication, that is, FIG. 6 is a diagram illustrating the selection status. The summing unit 13 obtains, for each indication number, the summed number of contact persons and reviewers who have not used the indication. For example, the summing unit 13 references the incident management table 21 to search for answer statements corresponding to business process A. The summing unit 13 selects the answer statements searched for, one by one, and, upon accepting input of the selected answer statement, reevaluates the answer statement by using, for example, the sample definition file 24. Then, for the indication number of an indicated item as a result of reevaluation, the summing unit 13 counts the number of contact persons and reviewers who have not used this indication on the original proofreading occasion. Note that the summing unit 13 is to avoid counting the same person more than once for the same indication number.

Here, for the indication number of “1”, the number of contact persons and reviewers who have not used this indication is two. For the indication number of “2”, the number of contact persons and reviewers who have not used this indication is m (for example, an integer greater than or equal to ten).

Thus, the summing unit 13 obtains, for each indication number, the summed number of contact persons and reviewers who have not used this indication, thereby being able to detect that it is valid that, for each indication number, the indication has not been used.

### Example of Determination Processing

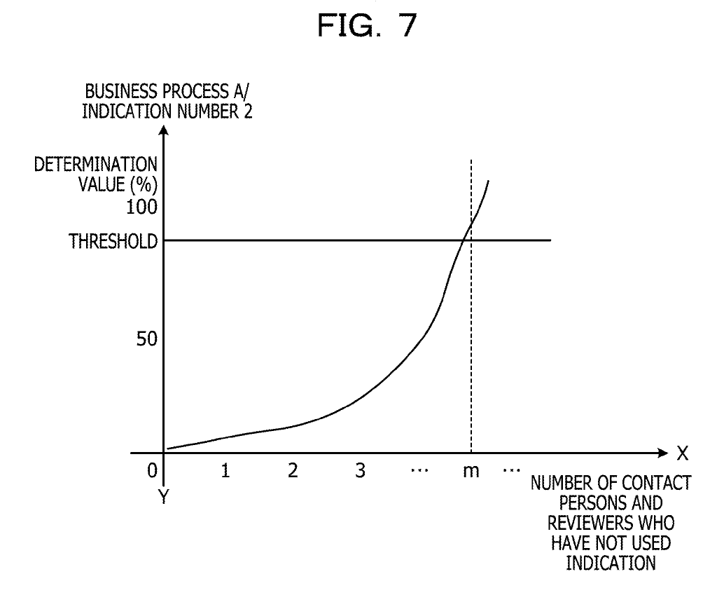

FIG. 7 is a diagram illustrating an example of determination processing according to an embodiment. Note that, in FIG. 7, determination processing in the case of the attribute category of business process A and the indication number of “2” is illustrated.

As illustrated in FIG. 7, assuming that the X-coordinate is the number of contact persons and reviewers who have not used an indication and the Y-axis is a determination value, a determination function is represented. By using this determination function, the determination unit 14 determines, for each indication number, whether it is valid that the indicated item with the indication number has not been used. For example, the determination unit 14 identifies the number of contact persons and reviewers who have not used the indication with an indication number “2”, which is obtained by the summing unit 13. Here, the identified number is assumed to be m. The determination unit 14 then references the determination function management table 23 and acquires the determination function corresponding to business process A. Here, it is assumed that “y=x²” is acquired as the determination function corresponding to business process A (refer to FIG. 4). By using the acquired determination function, the determination unit 14 then calculates a determination value corresponding to the summed number of contact persons and reviewers who have not used the indication with the indication number “2”. Then, when the calculated determination value is greater than or equal to a threshold, the determination unit 14 adds the indication number “2” for the indicated item to the white list. Here, the calculated determined value is greater than or equal to the threshold, and therefore the indication number “2” is added to the white list.

Thereafter, the definition file generation unit 15 identifies a definition file corresponding to business process A from the definition file management table 22. The definition file generation unit 15 reads the identified definition file and removes indicated items with indication numbers set in the white list among indication numbers defined in the definition file. Then, the definition file generation unit 15 generates the definition file 25 corresponding to business process A, assuming that the indicated items with indication numbers left after the removal are indicated items corresponding to business process A. Here, the definition file generation unit 15 generates the definition file 25 corresponding to business process A such that indication numbers other than the indication number “2” among indication numbers defined in the identified definition file are included in this definition file 25.

### Example of Definition File

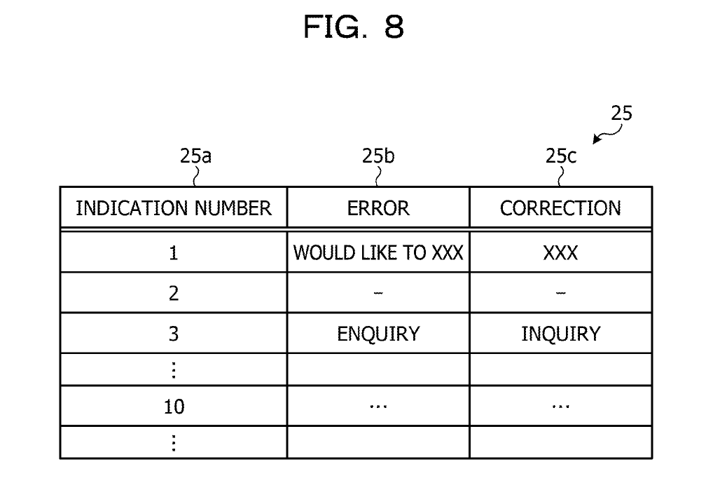

FIG. 8 is a diagram illustrating an example of a definition file of business process A. Note that FIG. 8 illustrates a definition file that the definition file generation unit 15 generates as the definition file 25 corresponding to business process A such that indication numbers other than the indication number “2” among the indication numbers defined in the sample definition file 24 are included in this definition file 25.

As illustrated in FIG. 8, the definition file 25 stores the indication number 25a, the error 25b, and the correction 25c in association with each other. The indication number 25a represents the number of identifying an indication. The error 25b represents the content of an item indicated as an error. The correction 25c represents the content of an item indicated as a correction. That is, with the error 25b and the correction 25c, what is to be modified and in what manner the modification is to be made is indicated.

By way of example, for the case of the indication number 25a of “1”, “would like to xxx” is stored as the error 25b and “xxx” is stored as the correction 25c. For the case of the indication number 25a of “2”, “-” is stored as the error 25b and “-” is stored as the correction 25c. This is because the indication number “2” is removed. For the case of the indication number 25a of “3”, “enquiry” is stored as the error 25b and “inquiry” is stored as the correction 24c.

### Example of Screen Image of Evaluation Process

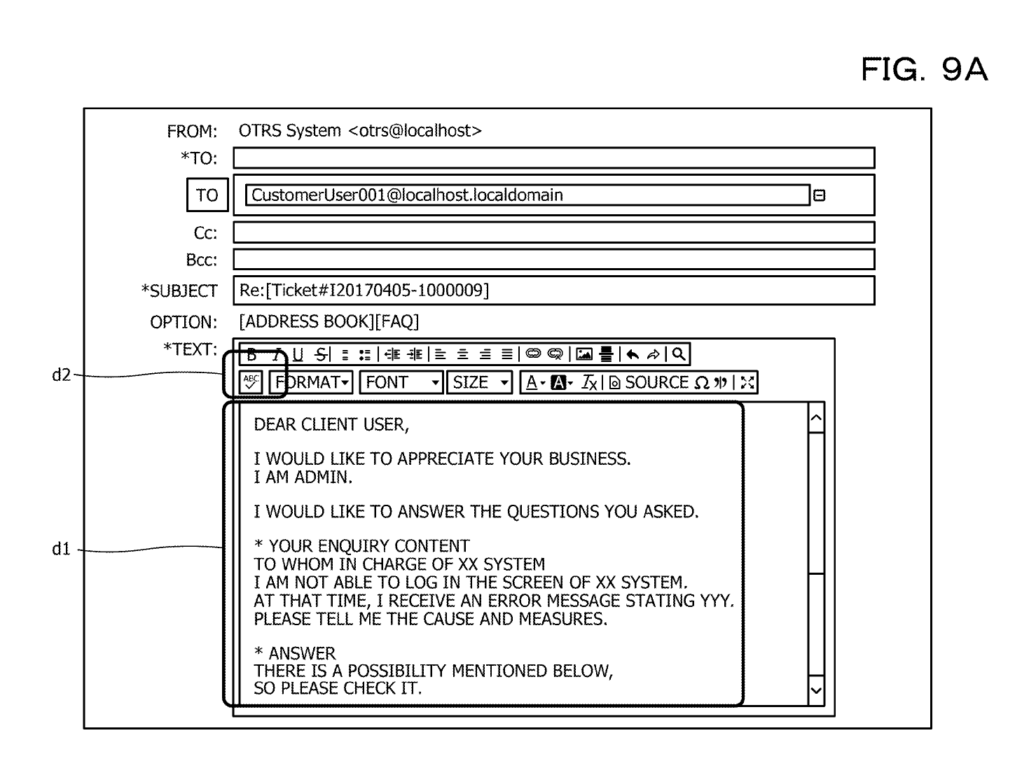

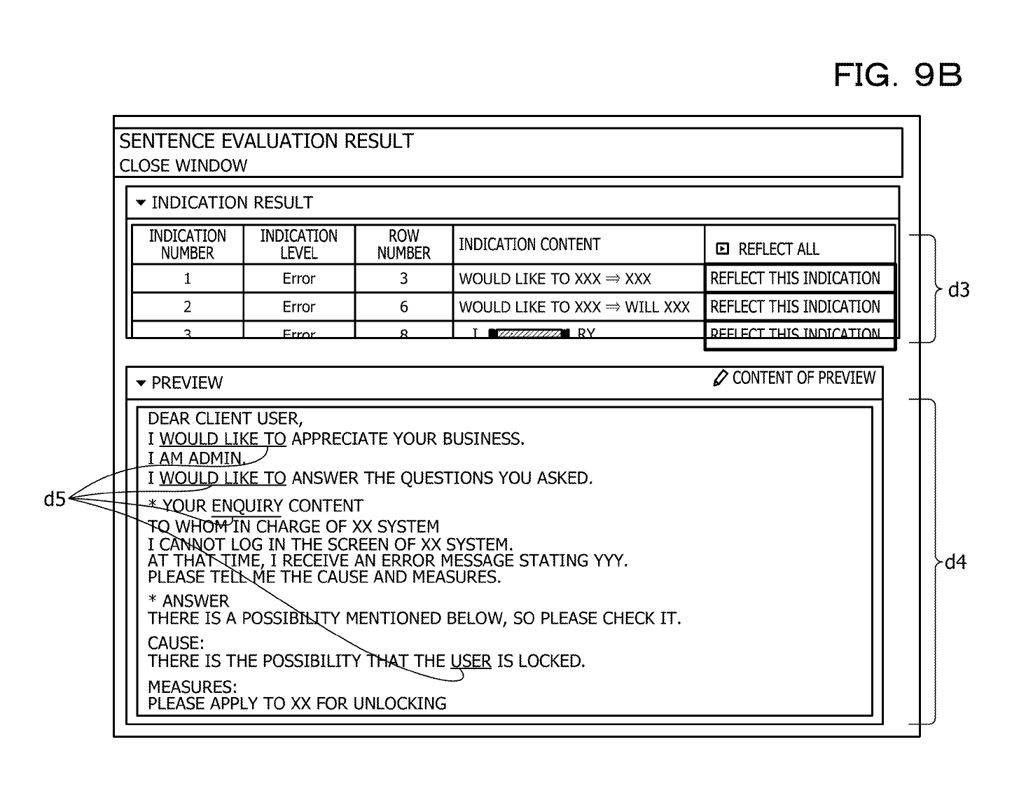

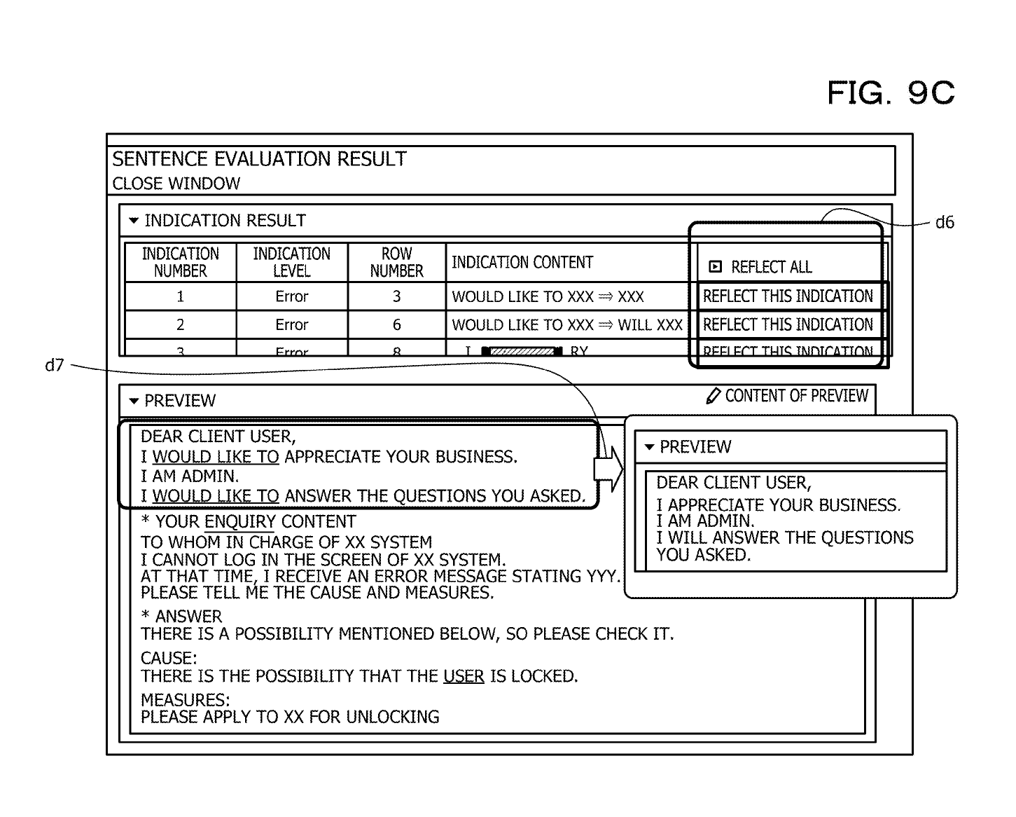

FIG. 9A to FIG. 9C are diagrams illustrating examples of screen images of an evaluation process according to an embodiment. Note that it is assumed that, in the incident management table 21, “g” is stored as the attribute 21d corresponding to an incident (inquiry) and “business process A” is stored as the business process name 21f. In addition, it is assumed that, in the definition file management table 22, business process A and the sample definition file 24 are associated with each other.

As illustrated in FIG. 9A, a contact person uses an evaluation screen to prepare an answer statement concerning an incident (inquiry). Here, an answer statement concerning an incident (inquiry) is displayed on an evaluation screen (d1). Upon preparing an answer statement, the contact person presses down an evaluation button on the evaluation screen (d2). Upon pressing down of the evaluation button, the identification unit 11 identifies the attribute category as business process A by referencing the incident management table 21. The evaluation unit 12 then identifies the sample definition file 24 corresponding to business process A by referencing the definition file management table 22, and evaluates the prepared answer statement by using the identified sample definition file 24.

As illustrated in FIG. 9B, an indication result is displayed on the evaluation screen (d3). In addition, in order for the contact person to verify the indication result, a preview is displayed on the evaluation screen (d4). In the preview, locations corresponding to the indication result are highlighted by underlining (d5). Note that highlighting is not limited to underlining and may be achieved, for example, by changing color or thickening a line.

As illustrated in FIG. 9C, when the contact person selects indications to be used (d6), the evaluation unit 12 automatically corrects the selected indications. Here, when the contact person selects an indication with an indication number “1” of “would like to xxx→xxx”, and an indication with the indication number “2” of “would like to xxx→will xxx”, the definition file generation unit 15 reflects the selected indications with indication numbers. That is, the evaluation unit 12 modifies the answer statement such that “would like to xxx” in the answer statement is replaced with “xxx” and “would like to xxx” in the answer statement is replaced with “will xxx” (d7).

Flowchart of Evaluation Process

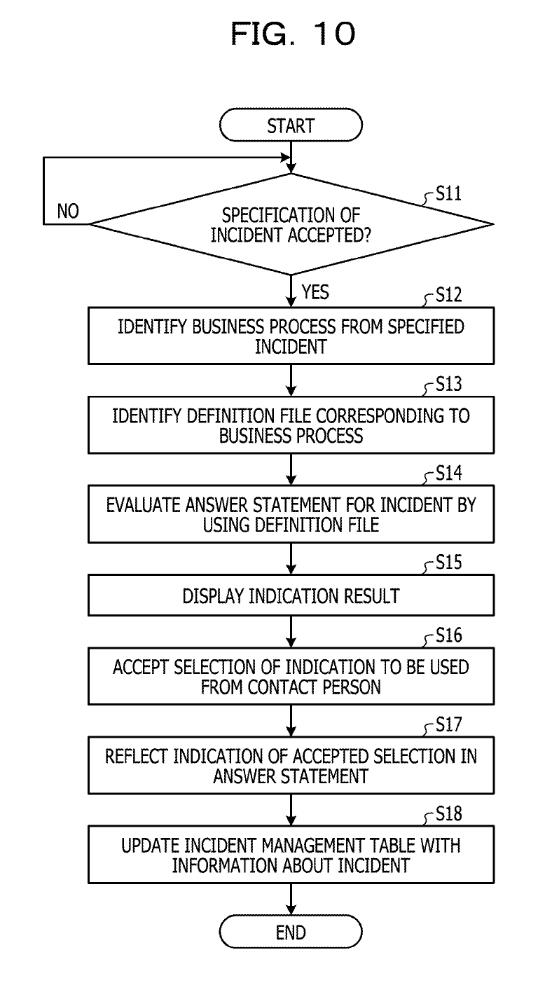

FIG. 10 is a diagram illustrating an example of a flowchart of an evaluation process according to an embodiment. Note that, with reference to FIG. 10, description will be given focusing on the case where the attribute is a business process. In addition, it is assumed that, in the incident management table 21, “g” is stored as the attribute 21d corresponding to an incident (inquiry) and “business process A” is stored as the business process name 21f. In addition, it is assumed that, in the definition file management table 22, business process A and the sample definition file 24 are associated with each other.

First, the identification unit 11 determines whether specification of an incident has been accepted (step S11). If it is determined that specification of the incident has not been accepted (step S11; No), the identification unit 11 repeatedly performs the determination processing until specification of an incident is accepted.

Otherwise, if it is determined that specification of an incident has been accepted (step S11; Yes), the identification unit 11 identifies a business process from the specified incident (step S12). For example, the identification unit 11 references the incident management table 21 to identify business process A as an attribute category corresponding to the incident (inquiry).

Then, the identification unit 11 identifies a definition file corresponding to the identified business process (step S13). For example, the identification unit 11 references the definition file management table 22 to identify the sample definition file 24 as a definition file corresponding to business process A.

Then, the evaluation unit 12 evaluates an answer statement for the incident by using the identified definition file (step S14). The evaluation unit 12 then displays an indication result on an evaluation screen (step S15).

Then, upon accepting selection of an indication to be used from the contact person (step S16), the evaluation unit 12 reflects the indication of the accepted selection in the answer statement (step S17). For example, the evaluation unit 12 modifies the answer statement such that the error 24b of the indication number 24a for the selected indication in the sample definition file 24 is replaced with the correction 24c.

The evaluation unit 12 then updates the incident management table 21 with the information about the incident (step S18). For example, by referencing the incident management table 21, the evaluation unit 12 extracts a record corresponding to the inquiry 21b that matches the incident (inquiry). The evaluation unit 12 updates the answer statement 21c of the extracted record with the corrected answer statement and updates the contact person 21h of the extracted record with the contact person name. In addition, upon approval of the answer statement 21c for the incident by a reviewer, if the reviewer is the approver, the evaluation unit 12 updates the approver 21i of the extracted record with the approver name. If the reviewer is a person in charge, the evaluation unit 12 updates the person in charge 21j of the extracted record with the name of the person in charge.

The evaluation unit 12 then ends the evaluation process.

Flowchart of Definition File Generation Process

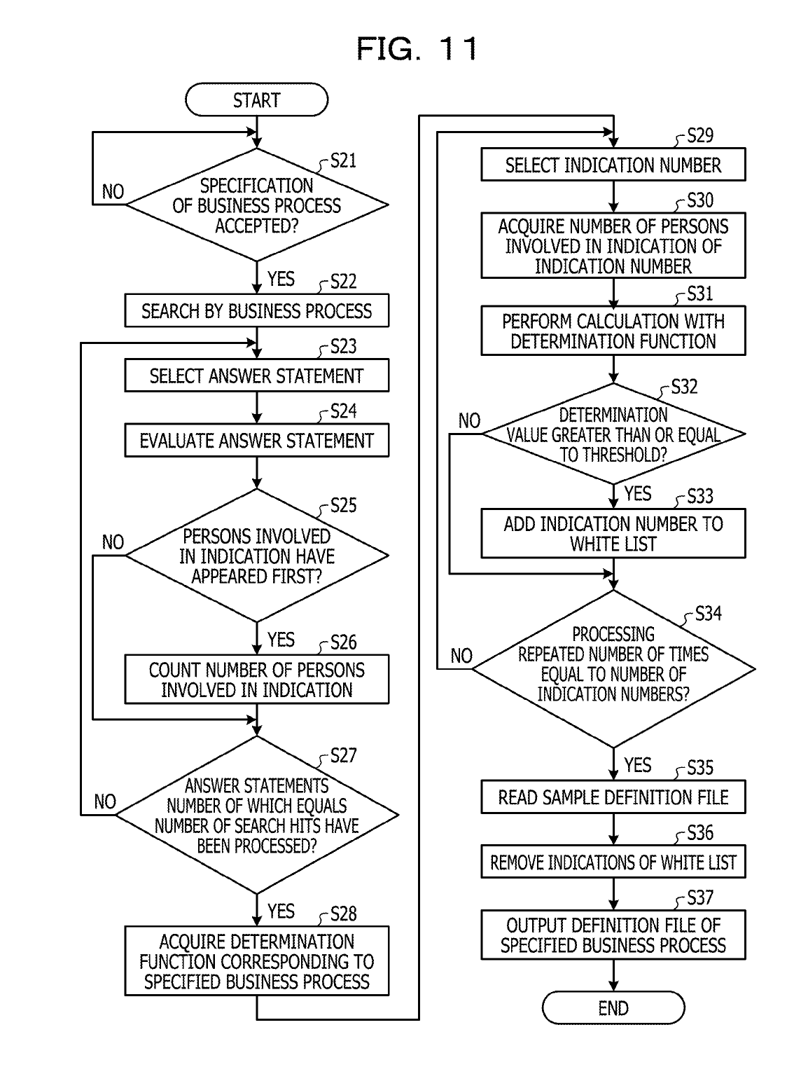

FIG. 11 is a diagram illustrating an example of a flowchart of a definition file generation process according to an embodiment. Note that, with reference to FIG. 11, description will be given focusing on the cases where the attribute is a business process. In addition, it is assumed that, in the definition file management table 22, business process A and the sample definition file 24 are associated with each other.

First, the summing unit 13 determines whether specification of a business process has been accepted (step S21). If it is determined that specification of a business process has not been accepted (step S21; No), the summing unit 13 repeatedly performs determination processing until specification of the business process is accepted.

Otherwise, if it is determined that specification of a business process has been accepted (step S21; Yes), the summing unit 13 references the incident management table 21 to search for answer statements corresponding to the specified business process (step S22). The summing unit 13 selects one answer statement from the answer statements searched for (step S23).

The summing unit 13 then evaluates the answer statement by using a definition file corresponding to the specified business process (step S24). The definition file is identified from the definition file management table 22. In the case where the business process is “business process A”, the sample definition file 24 is identified from the definition file management table 22.

The summing unit 13 then determines, for each indication number, whether persons involved in the indication have appeared for the first time (step S25). The persons involved in the indication include contact persons and reviewers such as approvers and persons in charge. If it is determined that the persons involved in the indication have appeared for the first time (step S25; Yes), the summing unit 13 counts, for each indication number, the number of persons involved in the indication (step S26). The summing unit 13 then proceeds to step S27.

Otherwise, if it is determined that the persons involved in the indication have not appeared for the first time (step S25; No), the summing unit 13 proceeds to step S27.

In step S27, the summing unit 13 determines whether the answer statements the number of which equals the number of search hits have been processed (step S27). If it is determined that the answer statements the number of which equals the number of search hits have not been processed (step S27; No), the summing unit 13 proceeds to step S23 to select an answer statement that has not been processed.

Otherwise, if it is determined that the answer statements the number of which equals the number of search hits have been processed (step S27; Yes), the determination unit 14 references the determination function management table 23 and acquires a determination function corresponding to the specified business process (step S28). The determination unit 14 then selects one indication number (step S29). The determination unit 14 then acquires the number of persons involved in the indication of the selected indication number (step S30). Then, by using the determination function, the determination unit 14 calculates a determination value corresponding to the number of persons involved in the indication (step S31).

Subsequently, the determination unit 14 determines whether the calculated determination value is greater than or equal to a threshold (step S32). If it is determined that the determination value is greater than or equal to the threshold (step S32; Yes), the determination unit 14 adds the selected indication number to the white list (step S33). Then, the determination unit 14 proceeds to step S34.

Otherwise, if it is determined that the determination value is not greater than or equal to the threshold (step S32; No), the determination unit 14 proceeds to steps S34.

In step S34, the determination unit 14 determines whether the above processing has been repeated the number of times equal to the number of indication numbers (step S34). If it is determined that the above processing has not been repeated the number of times equal to the number of indication numbers (step S34; No), the determination unit 14 proceeds to step S29 to select an indication number that has not been selected.

Otherwise, if it is determined that the above processing has been repeated the number of times equal to the number of indication numbers (step S34; Yes), the definition file generation unit 15 reads a specified definition file (step S35). The definition file is identified from the definition file management table 22. In the case where the business process is “business process A”, the sample definition file 24 is identified from the definition file management table 22.

The definition file generation unit 15 removes the indicated items of indication numbers set in the white list from the indicated items of indication numbers in the read definition file (step S36). That is, the definition file generation unit 15 generates the definition file 25 corresponding to the specified business process, assuming that the indicated items of a plurality of indication numbers left after the removal are indicated items corresponding to the identified business process.

The definition file generation unit 15 then outputs the definition file 25 of the specified business process (step S37). Then, the definition file generation unit 15 updates the definition file name 22b corresponding to the specified business process in the definition file management table 22, with the generated definition file 25. Then, the definition file generation unit 15 ends the definition file generation process.

Note that, in the foregoing embodiment, upon accepting specification of an attribute category for which generation of a definition file is desired, the summing unit 13 references the incident management table 21 to search for answer statements corresponding to the attribute category the specification of which has been accepted. The summing unit 13 selects the answer statements searched for, one by one, and, upon accepting input of the selected answer statement, reevaluates the answer statement by using the identified definition file. For the indication number for an item indicated as a result of reevaluation, the summing unit 13 counts the number of contact persons and reviewers involved in this indication on the original evaluation occasion. However, the summing unit 13 is not limited to performing this and may sum the numbers of contact persons and reviewers both of which are weighted. For example, the summing unit 13 may sum the numbers of contact persons and reviewers that are respectively weighted in accordance with the years of experience of the attribute categories. Thus, the summing unit 13 obtains the summed number of contact persons and reviewers involved in an indication by summing the weighted numbers of contact persons and reviewers involved in the indication, and thus the summing unit 13 is able to detect that it is valid that this indication has not been used. Summing makes it possible to accurately detect that it is valid that this indication has not been used.

### Advantages of Embodiment

In this way, upon accepting specification of an incident, the evaluation apparatus 1 identifies an attribute category corresponding to the specified incident by referencing the incident management table 21 in which management information of incidents is stored. The evaluation apparatus 1 identifies a definition file corresponding to the identified attribute category by referencing the definition file management table 22 in which a definition file regarding evaluation of an answer statement regarding an incident is stored for each attribute category. Upon accepting input of an answer statement regarding the specified incident, the evaluation apparatus 1 evaluates the input answer statement, based on the identified definition file. With such a configuration, the evaluation apparatus 1 may support preparation of an answer statement in accordance with the attribute category. For example, when an answer statement for an incident is evaluated, the evaluation apparatus 1 is able to automatically change a definition file regarding the evaluation, in accordance with a user who has issued the incident, a business process, or a use case. As a result, the evaluation apparatus 1 is able to evaluate an answer statement by using the automatically changed definition file and is able to modify the answer statement based on an evaluation result.

Furthermore, the evaluation apparatus 1 modifies an answer statement based on an indicated item selected from a plurality of indicated items regarding evaluation of the answer statement. With such a configuration, the evaluation apparatus 1 does not collectively modify an answer statement for a plurality of indicated items but is able to modify the answer statement for a selected indicated item, thereby being able to achieve modification in accordance with the attribute category of the answer statement.

Furthermore, the evaluation apparatus 1 identifies a selection status associated with an identified attribute category by referencing information representing an association relationship between the selection status of a plurality of indicated items regarding evaluation of an answer statement and the attribute category. The evaluation apparatus 1 generates a definition file corresponding to the identified attribute category in accordance with the identified selection status. With such a configuration, the evaluation apparatus 1 is able to automatically generate a definition file in accordance with an attribute category by using a selection status of indicated items associated with the attribute category.

Furthermore, the evaluation apparatus 1 calculates a determination value corresponding to the identified selection status by using a determination function corresponding to an attribute category, the determination function associating a selection status with a determination value that determines whether selection is valid. The evaluation apparatus 1 generates a definition file corresponding to the attribute category by using the calculated determination value. With such a configuration, the evaluation apparatus 1 uses a determination function corresponding to an attribute category, thereby being able to automatically generate a definition file in accordance with the attribute category.

Furthermore, the evaluation apparatus 1 displays, on an evaluation screen, a plurality of operative components respectively associated with a plurality of indicated items regarding evaluation of an answer statement. The evaluation apparatus 1 identifies the acceptance status of operations associated with an identified attribute category by referencing information representing the association relationship between the acceptance status of operations of the plurality of displayed operative components and the attribute category. The evaluation apparatus 1 updates a definition file based on the identified acceptance status of operations. With such a configuration, the evaluation apparatus 1 uses an acceptance status of indicated items, which is associated with an attribute category, and thereby the evaluation apparatus 1 is able to automatically generate a definition file in accordance with the attribute category.

Others

Note that, in the embodiment, for an attribute category (for example, a business process), indicated items determined not to be used when the answer statement is evaluated by the evaluation unit 12 are the target of summing. That is, for the indication number for an indicated item indicated as a result of reevaluation, the summing unit 13 counts the number of contact persons and reviewers involved in this indication when the answer statement is evaluated by the evaluation unit 12. Then, for each indication number, the determination unit 14 calculates a determination value corresponding to the number of contact persons and reviewers involved in the indication, and, if the calculated determination value is greater than or equal to a threshold, the determination unit 14 adds the indication number for the indicated item to the white list. That is, indicated items intended for use in a business process are set in the definition file 25, and therefore the white list into which unnecessary indicated items among items included in the sample definition file 24 are input is utilized. However, embodiments are not limited to this; a business process to be used in an indicated item may be set in the definition file 25, and an embodiment may be the case where an unnecessary business process list into which unnecessary business processes among business processes included in the sample definition file 24 are put is utilized.

In such a case, for an indicated item, a business process determined not to be used when the answer statement has been evaluated by the evaluation unit 12 is the target of summing. That is, for a business process determined not to be used as a result of reevaluation, the summing unit 13 counts the number of contact persons and reviewers involved in the determination not to use this business when the answer statement has been evaluated by the evaluation unit 12. Then, for each indication number, the determination unit 14 calculates a determination value corresponding to the number of contact persons and reviewers involved in the determination not to use this business process, and, if the calculated determination value is greater than or equal to a threshold, the determination unit 14 adds the business process name for this business process to the unnecessary business process list. Then, except for business process names set in the unnecessary business process list for the indicated items among the names of business processes for which indicated items are defined in the sample definition file 24, the definition file generation unit 15 may generate the definition file 25 for indicated items.

Furthermore, the evaluation apparatus 1 is able to be implemented by equipping a known information processing apparatus, such as a personal computer or a workstation, with the functions of the control unit 10, the storage unit 20, and the like mentioned above.

Furthermore, in the foregoing embodiment, each component of the devices illustrated in the drawings may not be physically configured as strictly as illustrated in the drawings. That is, specific manners in which devices are distributed and integrated are not limited to those illustrated in the drawings, and all or some of the devices are able to be configured to be functionally or physically distributed and integrated in any units in accordance with various loads and usage statuses. For example, the summing unit 13 and the determination unit 14 may be integrated. The evaluation unit 12 may be distributed as a proofreading unit that proofreads an answer statement and a correction unit that corrects the answer statement based on the proofread result. The storage unit 20 may be an external device of the evaluation apparatus 1 and may be coupled via a network.

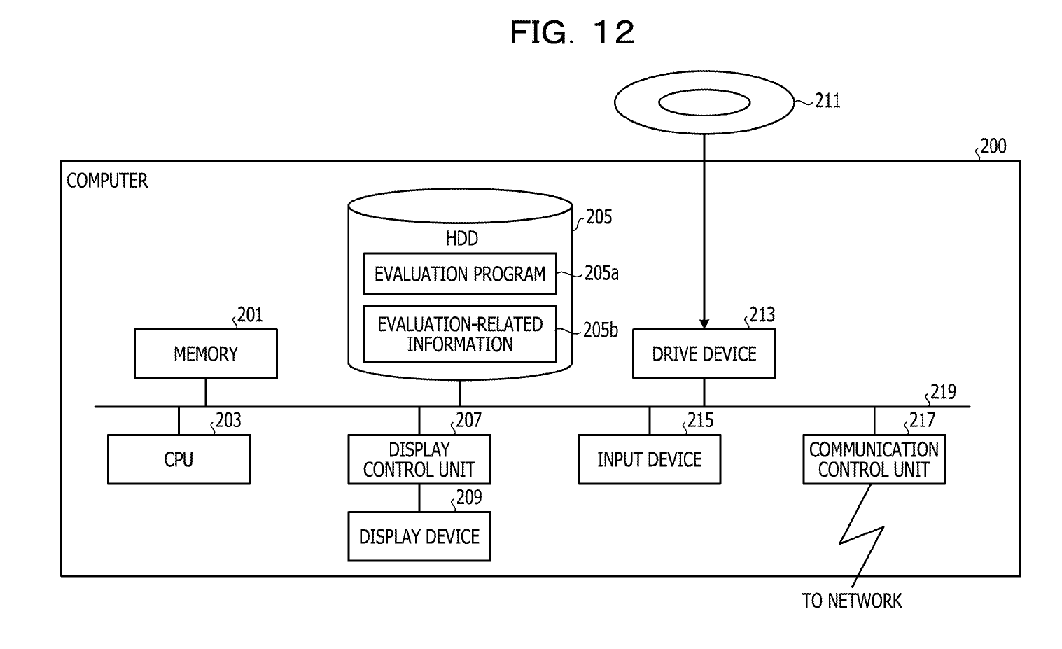

Furthermore, various processes described in the foregoing embodiment are able to be implemented by programs prepared in advance when the programs are executed by a computer, such as a personal computer or a workstation. Accordingly, an example of a computer that executes an evaluation program that achieves functions similar to those of the evaluation apparatus 1 illustrated in FIG. 1 will be described below. FIG. 12 is a diagram illustrating an example of a computer that executes an evaluation program.

As illustrated in FIG. 12, a computer 200 includes a central processing unit (CPU) 203 that executes various types of arithmetic processing, an input device 215 that accepts input of data from the user, and a display control unit 207 that controls a display device 209. The computer 200 also includes a drive device 213 that reads a program and the like from a recording medium, and a communication control unit 217 that sends and receives data to and from another computer via a network. The computer 200 also includes a memory 201 that temporarily stores various types of information, and a hard disk drive (HDD) 205. The memory 201, the CPU 203, the HDD 205, the display control unit 207, the drive device 213, the input device 215, and the communication control unit 217 are coupled by a bus 219.

The drive device 213 is a device for, for example, a removal disk 211. The HDD 205 stores an evaluation program 205a and evaluation-related information 205b.

The CPU 203 reads the evaluation program 205a to load it in the memory 201 and execute it as processes. Such processes correspond to function units of the evaluation apparatus 1. The evaluation-related information 205b corresponds to the incident management table 21, the definition file management table 22, the determination function management table 23, the sample definition file 24, and the definition files 25. Furthermore, the removal disk 211, for example, stores each piece of information such as the evaluation program 205a.

Note that the evaluation program 205a does not have to be initially stored in the HDD 205. For example, the program is stored in a “portable physical medium”, such as a flexible disk (FD), a compact disc read-only memory (CD-ROM), a digital versatile disk (DVD), an optical magnetic disk, or an integrated circuit (IC) card, which is inserted into the computer 200. The computer 200 may read the evaluation program 205a from such a medium to execute this program.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An evaluation apparatus comprising:
a memory; and
a processor coupled to the memory and the processor configured to
specify, in response to receiving an answer regarding a first incident, a first incident category related to the first incident in accordance with management information of a plurality of incidents;
select a first criterion related to the specified first incident category from criterions regarding evaluation for each incident category;
perform evaluation of the answer in accordance with the selected first criterion; and
perform outputting a result of the evaluation of the answer.

2. The evaluation apparatus according to claim 1, the processor further configured to modify the answer on the basis of a first item selected from a plurality of items pointed out by the evaluation of the answer.

3. The evaluation apparatus according to claim 1, the processor further configured to
store a first selection result of a plurality of items pointed out by the evaluation and the first incident category in association with each other in association information that includes selection results of items for each incident category, and
in generation processing of a second criterion related to a second incident category, specify selection results associated with the second incident category in accordance with the association information, and perform generation of the second criterion in accordance with the specified selection results associated with the second incident category.

4. The evaluation apparatus according to claim 3, wherein the generation of the second criterion includes
calculating a first determination value in accordance with the selection result associated with the second incident category by using a determination function of the second incident category, the determination function being for calculating a determination value with which it is determined whether selection of an item is valid, and
generating the second definition information by using the calculated first determination value.

5. The evaluation apparatus according to claim 3,
wherein the outputting the result of the evaluation includes displaying, on a display, each of a plurality of operative components corresponding to each of the plurality of items pointed out by the evaluation, and
the processor further configured to determine the first selection result on the basis of an acceptance status of an operation with respect to the displayed plurality of operative components.

6. A computer-implemented evaluation method comprising:
specifying, in response to receiving an answer regarding a first incident, a first incident category related to the first incident in accordance with management information of a plurality of incidents;
selecting a first criterion related to the specified first incident category from criterions regarding evaluation for each incident category;
evaluating the answer in accordance with the selected first criterion; and
outputting a result of the evaluation of the answer.

7. The evaluation method according to claim 6, further comprising: modifying the answer on the basis of a first item selected from a plurality of items pointed out by the evaluation of the answer.

8. The evaluation method according to claim 6, further comprising:
storing a first selection result of a plurality of items pointed out by the evaluation and the first incident category in association with each other in association information that includes selection results of items for each incident category, and
in generation processing of a second criterion related to a second incident category, specifying selection results associated with the second incident category in accordance with the association information, and performing generation of the second criterion in accordance with the specified selection results associated with the second incident category.

9. The evaluation method according to claim 8, wherein the generation of the second criterion includes
calculating a first determination value in accordance with the selection result associated with the second incident category by using a determination function of the second incident category, the determination function being for calculating a determination value with which it is determined whether selection of an item is valid, and
generating the second definition information by using the calculated first determination value.

10. The evaluation method according to claim 8, wherein
the outputting the result of the evaluation includes displaying, on a display, each of a plurality of operative components corresponding to each of the plurality of items pointed out by the evaluation, and
the first selection result is determined on the basis of an acceptance status of an operation with respect to the displayed plurality of operative components.

11. A non-transitory computer-readable medium storing an evaluation program that causes a computer to execute a process comprising:
specifying, in response to receiving an answer regarding a first incident, a first incident category related to the first incident in accordance with management information of a plurality of incidents;
selecting a first criterion related to the specified first incident category from criterions regarding evaluation for each incident category;
evaluating the answer in accordance with the selected first criterion; and
outputting a result of the evaluation of the answer.

12. The medium according to claim 11, the process further comprising: modifying the answer on the basis of a first item selected from a plurality of items pointed out by the evaluation of the answer.

13. The medium according to claim 11, the process further comprising:
storing a first selection result of a plurality of items pointed out by the evaluation and the first incident category in association with each other in association information that includes selection results of items for each incident category, and
in generation processing of a second criterion related to a second incident category, specifying selection results associated with the second incident category in accordance with the association information, and performing generation of the second criterion in accordance with the specified selection results associated with the second incident category.

14. The medium according to claim 13, wherein the generation of the second criterion includes
calculating a first determination value in accordance with the selection result associated with the second incident category by using a determination function of the second incident category, the determination function being for calculating a determination value with which it is determined whether selection of an item is valid, and
generating the second definition information by using the calculated first determination value.

15. The medium according to claim 13, wherein
the outputting the result of the evaluation includes displaying, on a display, each of a plurality of operative components corresponding to each of the plurality of items pointed out by the evaluation, and
the first selection result is determined on the basis of an acceptance status of an operation with respect to the displayed plurality of operative components.
